(19) United States
(12) Patent Application Publication
(10) Pub. No.: US 2004/0191402 A1
(43) Pub. Date: Sep. 30, 2004

(54) Confectionery with fast flavor release jacket coating

(75) Inventors: Barbara Z. Stawski, Forest Park, IL (US); Marc A. Bernicky, Plainfield, IL (US)

Correspondence Address: WRIGLEY & DREYFUS 28455, BRINKS HOFER GILSON & LIONE, P.O. BOX 10395, CHICAGO, IL, 60610, US

(73) Assignee: Wm. Wrigley Jr. Company

(21) Appl. No.: 10/810,461

(22) Filed: Mar. 26, 2004

Related U.S. Application Data
(60) Provisional application No. 60/457,954, filed on Mar. 26, 2003.

(51) Int. Cl. A23L 1/30

(52) U.S. Cl. 426/658

(57) ABSTRACT

A jacketed hard candy product comprises a core made of a boiled hard candy containing one or more flavoring and cooling agents, and an outer layer also made of a boiled hard candy and containing one or more flavoring and cooling agents. The outer layer is jacketed onto the core so as to cover at least a majority of the core. The level of cooling agents in the outer layer is greater than the level of any cooling agents in the core.

### REFERENCE TO EARLIER FILED APPLICATION

The present application claims the benefit of the filing date under 35 U.S.C. § 119(e) of Provisional U.S. Patent Application Serial No. 60/457,954, filed Mar. 26, 2003; which is hereby incorporated by reference in its entirety.

### BACKGROUND OF THE INVENTION

The present invention relates to confections, and particularly to boiled hard candy types of confectionery with a fast flavor release jacket coating.

Many different boiled hard candy confections are known, such as suckers, starlight mints, butterscotch buttons, etc. Many of these confections are made with water, sucrose and corn syrup, boiled to a water content level that results in a hard candy when the material cools. Different flavoring agents and colors may be added, usually after the candies are cooked but still hot enough to be fluid. Adding the flavoring agents at this stage reduces the tendency of volatile flavors to boil off.

Some hard candy products have different layers, or areas within the candy that have a different composition. For example, candy canes combine white and red boiled hard candies so as to give spiral shaped red stripes on the outside of the white cylindrical body, which is then bent into a cane shape. Starlight mints are similarly made, but are larger in diameter and are cut off and formed into disks with multiple green or red zones around the periphery of the candy.

However, even with these known varieties of candies, there is still a need for a boiled hard candy that has a high initial cooling flavor impact when first placed in the mouth, followed by a more mellow flavor as the hard candy continues to dissolve while being sucked.

Further, many mint flavored candies include menthol or other cooling agents to give a cooling sensation when consumed. However, is some countries, food product regulations limit the level that some cooling agents can be used in products. Hence, it would be highly advantageous if a boiled hard candy product, and method of making the product, could be developed that would provide a fast, intense cooling flavor followed by more mild flavor, yet still meet applicable government regulations.

### BRIEF SUMMARY OF THE INVENTION

A boiled hard candy confectionery with a fast flavor release jacket coating has been invented. A boiled hard candy product is produced with a concentrated level of flavor in a jacket layer by adding a higher level of cooling agent to a portion of the boiled hard candy that is jacketed onto the surface of a center portion of the hard candy. This gives a hard candy product having a fast intense flavor initially, with a flavor that diminishes, leaving a mild flavored hard candy having good consumer acceptability. The product has a fast, intense flavor release, or “kick” flavor release, followed by a milder more pleasantly flavored product.

In a first aspect, the invention is a jacketed hard candy product comprising; a core made of a boiled hard candy containing one or more flavoring and cooling agents; and an outer layer also made of a boiled hard candy and containing one or more flavoring and cooling agents, the outer layer being jacketed onto the core so as to cover at least a majority of the core, and the level of cooling agents in the outer layer being greater than the level of any cooling agents in the core.

In a second aspect, the invention is a method of making jacketed hard candy products comprising the steps of: cooking a composition to form a first sweetened mass; mixing one or more flavoring and cooling agents into the first sweetened mass; providing a second sweetened mass; mixing one or more flavoring and cooling agents into the second sweetened mass such that the level of the cooling agents in second sweetened mass is higher than the level of any cooling agents in the first sweetened mass; and forming jacketed hard candy products wherein the first sweetened mass is used to form a core and the second sweetened mass is used to form an outer layer covering at least a majority of the core.

One of the additional benefits of the invention is that the overall level of the cooling agents in the product can be within government regulations, yet the product can have a higher initial cooling impact than would be possible if the cooling agents were uniformly dispersed throughout the product, even at the highest possible level permitted by regulation.

These and other advantages of the invention, as well as the invention itself, will best be understood in conjunction with the accompanying drawings.

### BRIEF DESCRIPTION OF THE DRAWINGS

FIG. 1 is a perspective view of a preferred product of the present invention.

FIG. 2 is a cross-sectional view taken along line 2-2 of FIG. 1.

FIG. 3 is a schematic diagram showing a first embodiment of the method of the present invention.

FIG. 4 is a schematic diagram showing a second embodiment of the method of the present invention.

### DETAILED DESCRIPTION OF DRAWINGS AND PREFERRED EMBODIMENTS OF THE INVENTION

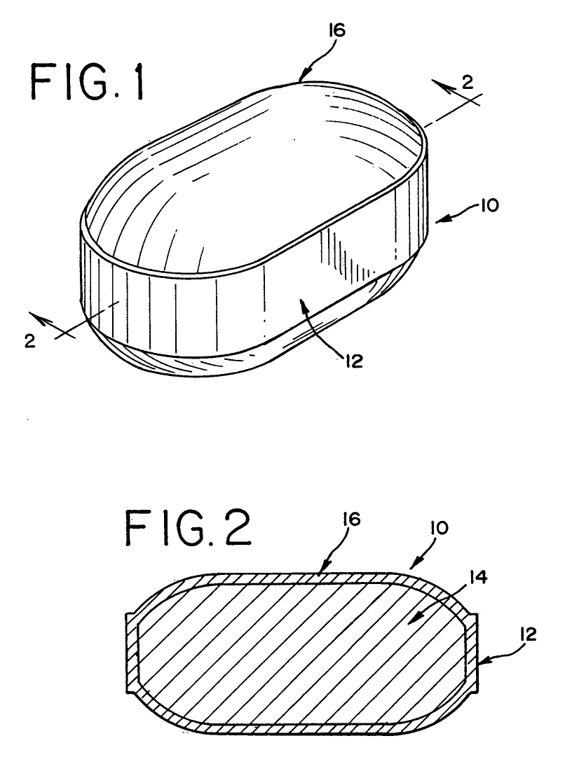

Unless specified otherwise, all percentages herein are weight percentages. While products of the present invention may be made in a wide variety of shapes, a preferred hard candy 10 made according to the present invention is shown in FIGS. 1 and 2. The candy 10 has an elongated shape and may be about 0.75 inches long, about 0.5 inches wide and about 0.25 inches high. Due to the die former, a flattened band 12 may be formed on the periphery of the candy 10.

As best seen in FIG. 2, the hard candy 10 has a core 14 and an outer layer 16. While the core 14 and outer layer 16 are shown in FIG. 2 as distinct, in a preferred embodiment of the invention, both the core 14 and outer 16 may appear as one homogenous material. Even if the hard candy 10 were sectioned, to the naked eye there would be no demarcation between the outer layer 16 and the core 14. In fact, if they are both clear like many hard candies, and colored the same way, it is very difficult to discern that the core 14 and outer layer 16 are distinct, rather the core and outer layers appear to be homogeneous. Also, while a distinct demarcation and relatively uniform thickness are shown in FIG. 2 for the outer layer 16, it is more likely that the actual interface between the core 14 and outer layer 16 will not be as smooth, nor will the thickness of the outer layer 16 be as uniform, in actual products.

The hard candy used to make the core 14 and outer layer 16 are preferable boiled hard candies made by a standard procedure for hard candy processing, which includes cooking syrup, cooling the syrup and adding flavors, plastifying or forming the mixture, stamping/forming or depositing the mixture, cooling, and packing.

Numerous variations on this standard procedure can be used to practice the invention. It is preferred that the material used to form the core and the material used to form the outer layer have the same basic composition and be made together to the extent possible. It is of course also possible that the core and outer layer materials be made completely independent of one another.

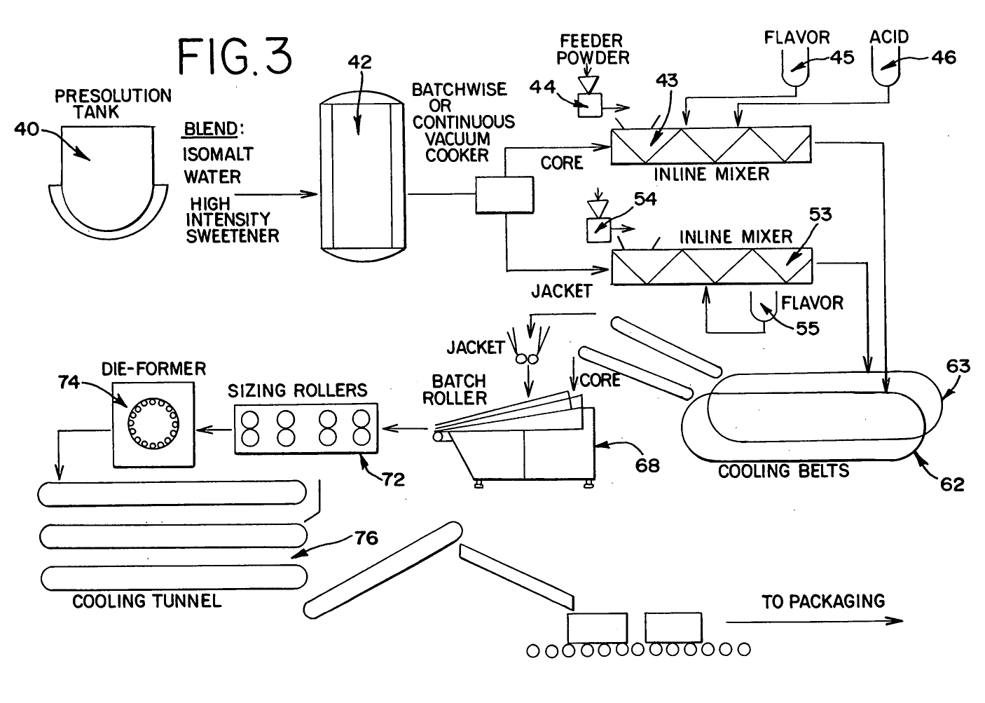

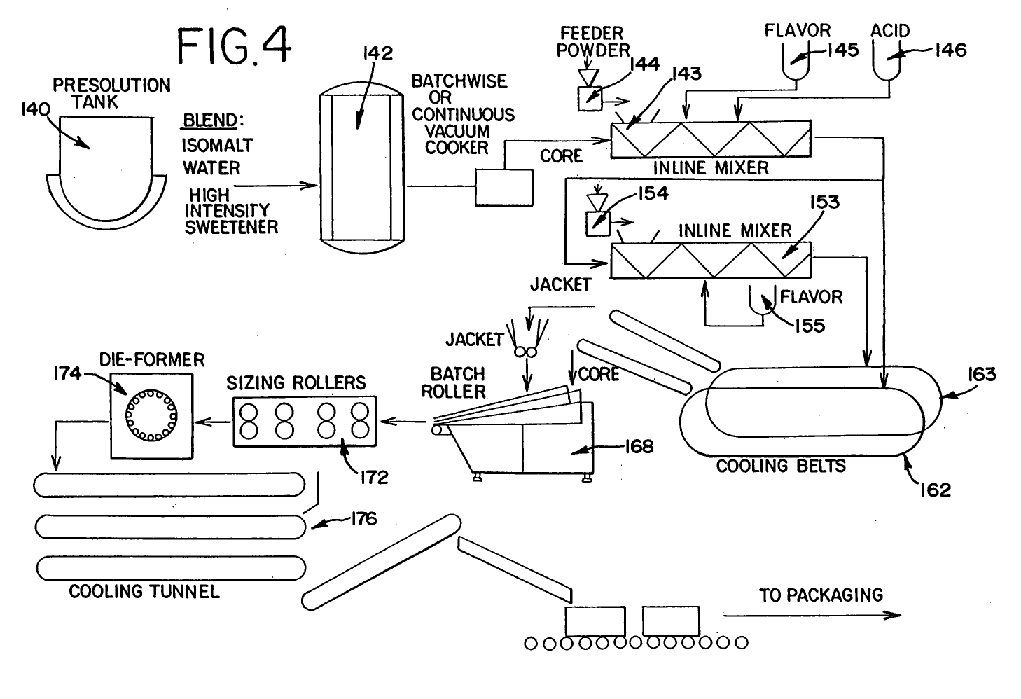

When the core and outer layer material are made together, there are two basic variations. In the first variation, shown in FIG. 3, the material for the core and jacket are separated right after the syrup is cooked and before the flavors are added. In the other variation, shown in FIG. 4, the syrup has some flavoring agents and/or cooling agents added, and then the portion used to form the jacket has additional flavoring and/or cooling agents added. Otherwise the two basic variations are very similar. In both methods, a first set of flavoring and cooling agents are mixed into the core portion and a second set of flavor and cooling agents are mixed into the jacket portion. Of course, the flavoring and cooling agents used in both sets may be the same or different. Each set may contain only one ingredient, or multiple ingredients. One or both of the sets may contain both flavoring and cooling agents. The level of cooling agents in the jacket material, however, is higher than the level of any cooling agents in the core portion.

The bulk sweetener, such as hydrogenated isomaltulose, water and preferably a high-intensity sweetener, such as acesulfame K, are blended together in a presolution tank 40. In some embodiments of the invention, a color and/or an acid may also be included at this stage. This material is held at a temperature that will keep the bulk sweetener dissolved. The temperature of the presolution tank may be in the range of 220-240° F. Next the blend is fed into a batchwise or continuous cooker 42, preferably a vacuum cooker, which may operate at a temperature in the range of 290-320° F. The cooked syrup is next separated (in the embodiment of FIG. 3), and the core portion, which is considered to be a first sweetened mass, is fed into an inline mixer 43, which may comprise a number of inlets and baffles. A powder feeder 44 may be used to add any dry flavoring and/or cooling agents and high-intensity sweetener. For example, a powder feeder can feed a blend of crystalline menthol and aspartame into one feed port in the inline mixer 43. One or more liquid tanks, such as flavor tank 45 and acid tank 46, may be used to hold liquid flavoring and cooling agents. In addition, these tanks may hold combinations of liquid ingredients. For example, the acid tank 46 may hold a combination of acid and high-intensity sweetener. A similar powder feeder 54 and flavor tank 55 may supply a second inline mixer 53 used to add flavoring and/or cooling agents to the remaining cooked syrup, referred to as a second sweetened mass, used to make the outer or jacket layer. Of course any number of powder feeders or tanks may be used to supply these ingredients. If a single tank supplies a flavor to the jacket layer, that flavor may include a cooling agent blended in with it.

The cooled and flavored core and jacket materials exit the inline mixers 43 and 53 at a temperature in the range of 240-260° F. From there they are deposited on cooling belts 62 and 63. The material used to form the core is fed into the head end of a batch roller 68 that forms the material into a continuous stream or rope. The material used to form the jacket is metered in on top of the rope of core material and forms an outer layer on the continuous rope. The cross sectional area of the jacketed rope is reduced by sizing rollers 72 to get the product to a desired size. Preferably a die former 74 is then used to form individual products from the jacketed rope. These products may be cooled in cooling tunnel 76 before being wrapped and packaged.

The equipment used in the embodiment of FIG. 4 may be exactly the same. Thus the same reference numbers used in FIG. 3 have been used with an addend of 100 to identify the equipment in FIG. 4. Thus, the bulk sweetener, water and high-intensity sweetener are held in presolution tank 140 and cooked in batchwise or continuous vacuum cooker 142. In this embodiment, all of the material enters inline mixer 143. After having flavoring and/or cooling agents mixed in, one portion is separated off as the core portion and deposited on cooling belt 162. The other portion, which is the jacket portion, is fed into inline mixer 153 where cooling agents and optionally flavoring agents and high-intensity sweetener are added. The jacket material is then deposited on cooling belt 163. Thereafter the process is exactly the same as in FIG. 3. In the preferred method embodiment of the present invention, the jacket material is added to the batch roller and covers or jackets the core material at a rate of about 5%-30% of the core material.

The hard candy product will preferably be made from bulk sweeteners selected from the group consisting of sugars, corn syrup, polyols, hydrogenated starch hydrolysate syrup and combinations thereof. The boiled hard candies of the core and outer layer are preferably both made from the same one or more bulk sweeteners.

A conventional hard candy formulation may be used to make this jacketed product. Conventional hard candies are made with sucrose and corn syrup blends. A blend of 60/40 is a typical sucrose/syrup blend made for hard candy. Other sugars such as dextrose or lactose, along with corn syrups, may also be used for making a hard candy. For a sugarless product, polyols are generally used, such as hydrogenated isomaltulose (which is also called isomalt), xylitol, maltitol and hydrogenated starch hydrolysates (HSH). In addition, isomalt/xylitol blends, isomalt/maltitol blends, isomalt/hydrogenated starch hydrolysate blends or maltitol/HSH blends may be used. It is also possible to use sorbitol or lactitol for making hard candy. Another possibility is the use of polydextrose, a sugarless bulking agent for making hard candy. However the preferred polyol for making a hard candy is isomalt. In addition to bulk sweeteners, high-intensity sweeteners such as acesulfame K, aspartame, alitame, sucralose, glycyrrhizin, saccharin and cyclamates may also be included in the hard candy. Depending on the particular high-intensity sweetener, a level of about 0.001% to about 2% in a hard candy may be used.

One or more flavoring agents are preferably added at a level of about 0.01% to about 2% by weight of the product. Preferably one or more flavoring agents will be used in both the core material and the jacket material. The flavoring agents may comprise essential oils, synthetic flavors, or mixtures including but not limited to oils derived from plants and fruits such as citrus oils, fruit essences, peppermint oil, spearmint oil, clove oil, oil of wintergreen, anise and the like. Artificial flavoring components are also contemplated for use in the hard candy of the present invention. Typical artificial fruit flavors include fruit esters and fruit essential oils. In addition, fruit flavored products require the use of food acids to give the desired sensory attributes. The term “flavoring agents” as used herein includes such food acids. Those skilled in the art will recognize that natural and artificial flavoring agents may be combined in any sensorially acceptable blend. All such flavors and flavor blends are contemplated by the present invention.

In addition, one or more cooling agents, such as menthol and physiological cooling agents (sometimes referred to as high-intensity coolants), are added at least to the jacket material. Preferably the one or more cooling agents are added to the hard candy at a level of about 0.001% to about 1%. These cooling agents may be preblended with the flavor before being added to the mixture of ingredients used to form the hard candy. Menthol may be preblended with the flavor or may be added to the hard candy composition in its crystalline form. Preferably the outer layer will contain about 0.01% to about 2% menthol. Typical cooling agents include substituted p-menthane carboxamides, acyclic carboxamides, menthone glycerol ketals, menthyl lactate, menthyl succinate, menthyl glutarate, 3-l-menthoxypropane-1,2 diol, l-isopulegol, p-menthane-3,8-diol and mixtures thereof. A preferred physiological cooling agent is N,2,3-trimethyl-2-isopropyl butanamide, preferably used at a level of between about 0.002% and about 0.015% of the product. Another preferred physiological cooling agent is 3-l-menthoxypropane-1,2 diol, preferably used at a level between about 0.005% and about 0.05% of the product. In preferred embodiments of this invention using menthol, the ratio of the level of menthol in the candy jacket to that in the core is preferably at least 1.5, and more preferably at least 2.0. This same ratio may also apply to the high-intensity cooling agents when added to the core and jacket. In some cases, cooling agents may not be added to the hard candy core, but only added to the hard candy jacket. Flavoring and/or cooling agents, may be added to the hard candy core or jacket material using the in-line mixer described above, or may be added manually by pouring over the hard candy mass and folding the hard candy mass to mix in the flavor/coolants.

Colors and other additives are also contemplated for use in the hard candy composition of this invention. Colors commonly used are FD&C dyes and lakes and some natural colors. Preferably, FD&C dyes are used. Other natural colors include colors such as chlorophyll, curcumin, caramel, carmine, annatto, and other similar types of colors. Other additives include ingredients such as dental agents, therapeutic and pharmaceutical agents, and vitamins, minerals, and herbal supplements. While both the core and jacket layers may comprise a color, one or both can be uncolored, and if a color is used, it may be the same or different in the core and jacket hard boiled candies.

Hard candy equipment is available from various companies that specialize in this type of equipment. Hard candy equipment includes batch and continuous cookers, jacketing or laminating equipment, batch rollers, forming and packaging machinery. One such company is Robert Bosch, GmbH of Gernany with an agent in the U.S. located in Bridgman, Mich. Another equipment supplier of hard candy equipment is Chocotech, GmbH of East Aurora, N.Y. Other suppliers are Ruffinatti of East Boston, Mass., and Hosokawa Bepex GmbH of Boise, Id.

Equipment may be used to divide the hard candy mass after cooking into a primary mass of about 70-95% and a secondary mass of about 5-30%. As noted above, the mass may be divided after the flavor/menthol and high-intensity sweetener are added using an in-line mixer, as in FIG. 4, or, as shown in FIG. 3, the mass may be divided before the flavor/menthol and high-intensity sweetener are added, and flavor/menthol and high-intensity sweetener are added in two in-line mixers. After the two masses are flavored and cooled slightly, the jacketing batch roller combines the masses at a ratio of 70-95% primary mass (or core) to 5-30% secondary mass (or jacket). Preferably, the candy mass is combined at a ratio of 80%-95% core mass and 5-20% jacket mass, more preferably 80-90% core mass and 10-20% jacket mass, and most preferably the outer layer comprises about 15% by weight of the total product. In some cases, after flavoring and high-intensity sweetener are added, the two hard candy masses may be co-extruded to form the final product.

The outer layer will cover a majority, and preferably about 80% or more of the core. When the jacket comprises about 10% of the total product weight, it will typically cover about 80% of the core. When the jacket comprises about 15% or more of the total product weight, it will usually cover substantially all of the core, meaning that except for minor imperfections on some pieces, the surface area of the core will be totally covered by the jacket material.

As noted previously, hard candy may be made with sucrose/syrup blends or with isomalt for sugarless hard candy. In the present invention, the hard candy is preferably made of an uniform material which is then divided into two portions or masses. One portion is the core, which contains bulk sweeteners and may contain flavoring agents, high-intensity sweeteners, and color, and is about 70%-95% of the total product, most preferably 90%. The second portion, which contains all of the same ingredients, is divided out so that additional cooling agents, such as menthol, and possibly additional flavoring agents and a high-intensity sweetener may be added. In other instances, if the cooked hard candy is divided before flavor and high-intensity sweetener are added, flavor/menthol and high-intensity sweetener would be added to the core portion and a higher flavor/menthol level and high-intensity sweetener would preferably be added to the outer portion or jacket portion of the product. Of course the first mass may comprise one or more flavoring agents but no cooling agents.

### EXAMPLES

The following sugarless formulations were made in the following examples (all data below are in weight percent):

The example formulations were prepared by first mixing isomalt and acesulfame sweetener in water at a level of 75-80% solids. These materials were mixed at about 220°-230° F. to dissolve the isomalt in a preblend tank. The mixture was then pumped into a continuous vacuum cooker and heated to 290-310° F. to obtain a cooked hard candy mass having the formulation noted in Table 1.

TABLE 1

| | Example 1 | Example 2 | Example 3 | Example 4 | Example 5 |
|---|---|---|---|---|---|
| Isomalt | 98.95 | 98.95 | 98.95 | 98.95 | 98.95 |
| Water | 1.00 | 1.00 | 1.00 | 1.00 | 1.00 |
| Acesulfame | 0.05 | 0.05 | 0.05 | 0.05 | 0.05 |

The preblended cooked mass was then pumped into an in-line mixer where the flavor, menthol, sweetener, citric acid, and color were added to the preblend at the levels in Table 2:

TABLE 2

| | Example 1 | Example 2 | Example 3 | Example 4 | Example 5 |
|---|---|---|---|---|---|
| Preblend | 98.73 | 98.64 | 98.14 | 97.99 | 98.86 |
| Flavor | 0.89 | 0.93 | 1.20 | 1.30 | 0.33 |
| Menthol | 0.25 | 0.30 | 0.20 | 0.25 | 0.39 |
| Aspartame | 0.10 | 0.10 | 0.10 | 0.10 | 0.10 |
| Citric Acid | — | — | 0.34 | 0.34 | 0.30 |
| Color | 0.03 | 0.03 | 0.02 | 0.02 | 0.02 |
| Total | 100.0 | 100.0 | 100.0 | 100.0 | 100.0 |

Examples 1 and 2 were flavored with a menthol/eucalyptus flavor containing a high-intensity coolant. Examples 3, 4, and 5 were flavored with blackcurrant flavor that also contained a high-intensity coolant. Menthol was preblended with the flavor before being added to the preblended hard candy, whereas citric acid and aspartame were dissolved in water at a solids level of between about 40% and 44% before addition.

After some cooling to about 250° F. (120° C.), the hard candy mass was then divided into the core portion, using about 90% of the batch, and the jacket or outer layer portion, using the remaining 10% of the batch. Additional flavor/menthol or menthol, as shown in Table 3, was added to the jacket portion to give the final composition of the outer layer:

TABLE 3

| | Example 1 | Example 2 | Example 3 | Example 4 | Example 5 |
|---|---|---|---|---|---|
| Flavor | 0.091 | 0.054 | — | — | — |
| Menthol | 0.635 | 0.391 | 0.632 | 0.723 | 0.586 |

Flavor and menthol were mixed together before being added to the jacket portion of the hard candy. Where only menthol was used, powdered menthol was sprinkled onto the hard candy and folded to mix the menthol into the product. Table 4 gives the final composition of the jacket portion of the hard candy:

TABLE 4

| | Example 1 | Example 2 | Example 3 | Example 4 | Example 5 |
|---|---|---|---|---|---|
| Isomalt | 97.96 | 98.15 | 97.47 | 97.33 | 98.22 |
| Flavor | 0.98 | 0.98 | 1.19 | 1.19 | 0.33 |
| Menthol | 0.88 | 0.69 | 0.83 | 0.97 | 0.98 |
| Aspartame | 0.10 | 0.10 | 0.10 | 0.10 | 0.10 |
| Acesulfame | 0.05 | 0.05 | 0.05 | 0.05 | 0.05 |
| Citric Acid | — | — | 0.34 | 0.34 | 0.30 |
| Color | 0.03 | 0.03 | 0.02 | 0.02 | 0.02 |
| Total | 100.0 | 100.0 | 100.0 | 100.0 | 100.0 |

After some additional cooling to about 176° F. (80° C.), the jacket portion of the hard candy was used to coat or jacket the core portion of the hard candy in a laminating batch roller. The hard candy mass was then sized by sizing rolls and cut by a die former. The product was put through a cooling tunnel to bring the product to room temperature and wrapped. The final product was a 3.3 gram cylindrical piece having the shape shown in FIG. 1 with 10% jacket and 90% core.

The ratios of the level of menthol in the jacket compared to the level in the core for the foregoing Examples are as follows:

Example 1: 0.88/0.25=3.52

Example 2: 0.69/0.30=2.30

Example 3: 0.83/0.20=4.15

Example 4: 0.97/0.25=3.88

Example 5: 0.98/0.39=2.51

Sensory evaluation of the hard candy products of Examples 1-5 yielded products that had a strong initial flavor impact, then the flavor became milder and pleasant.

In an embodiment of the invention, the ratio of menthol level in the jacket to that in the core should be at least 1.5, and preferably at least 2.0. This allows the cooling flavor to be perceived more quickly to give a strong initial flavor impact for a hard candy confection.

Additional examples can be made using high-intensity coolants mixed with flavor in the core and a higher level of high-intensity coolant blended with flavor in the jacket. Using the preblend syrup mixture of Examples 1-5, a solution of isomalt, acesulfame, and water can be prepared and cooked to make a cooked hard candy mass. The preblended cooked mass can be pumped into an in-line mixer where the flavor, high-intensity coolant, sweetener, citric acid, and color can be added at the levels in Table 5:

TABLE 5

| | | | | | Example |
|---|---|---|---|---|---|
| | Example 6 | Example 7 | Example 8 | Example 9 | 10 |
| Preblend | 98.82 | 98.91 | 98.33 | 98.21 | 99.22 |
| Flavor | 1.04 | 0.93 | 1.20 | 1.30 | 0.33 |
| Coolant | 0.01* | 0.03** | 0.01* | 0.03** | 0.03* |
| Aspartame | 0.10 | 0.10 | 0.10 | 0.10 | 0.10 |
| Citric Acid | — | — | 0.34 | 0.34 | 0.30 |
| Color | 0.03 | 0.03 | 0.02 | 0.02 | 0.02 |
| Total | 100.0 | 100.0 | 100.0 | 100.0 | 100.0 |

*N,2,3-trimethyl-2-isopropyl butanamide (WS-23) cooling agent.
**3-l-menthoxypropane-1,2-diol cooling agent

Examples 6 and 7 could be flavored with a eucalyptus flavor, whereas examples 8, 9 and 10 could be flavored with blackcurrant flavor. Coolant agents could be preblended with flavor before being added to the preblended hard candy, whereas acid and aspartame would be dissolved in water before addition.

As in previous Examples 1-5, the candy mass can be cooled and divided into the core portion and jacket portion at a ratio of 90/10 core to jacket. Additional flavoring and cooling agents are then added to the jacket portion to give the final composition of the outer jacket portions noted in Table 6:

TABLE 6

| | | | | | Example |
|---|---|---|---|---|---|
| | Example 6 | Example 7 | Example 8 | Example 9 | 10 |
| Isomalt | 98.80 | 98.70 | 98.27 | 98.22 | 99.04 |
| Flavor | 0.98 | 0.98 | 1.19 | 1.19 | 0.33 |
| Coolant | 0.04* | 0.14** | 0.03* | 0.08** | 0.16** |
| Aspartame | 0.10 | 0.10 | 0.10 | 0.10 | 0.10 |
| Acesulfame | 0.05 | 0.05 | 0.05 | 0.05 | 0.05 |
| Citric Acid | — | — | 0.34 | 0.34 | 0.30 |
| Color | 0.03 | 0.03 | 0.02 | 0.02 | 0.02 |
| Total | 100.0 | 100.0 | 100.0 | 100.0 | 100.0 |

*N,2,3-trimethyl-2-isopropyl butanamide (WS-23) cooling agent.
**3-l-menthoxypropane-1,2-diol cooling agent

The jacket portion of the hard candy can be used to coat or jacket the core portion of the hard candy in a laminating batch roller. After sizing and cutting, product can be cooled to room temperature and wrapped. In the Examples 6-10, the ratio of the level of cooling agent in the jacket to that in the core would be as follows:

Example 6: 0.04/0.01=4.0; Total coolant level=130 ppm

Example 7: 0.14/0.03=4.67; Total coolant level=410 ppm

Example 8: 0.03/0.01=3.0; Total coolant level=120 ppm

Example 9: 0.08/0.03=2.67; Total coolant level=350 ppm

Example 10: 0.16/0.03=5.33; Total coolant level=430 ppm

Adding a higher level of coolant to the jacket of the hard candy allows the cooling flavor to be perceived more quickly to give a strong initial impact for a hard candy confection. This also allows greater cooling impact without using high levels of coolants, which may be prohibitive in some countries due to food content regulation.

It should be appreciated that the apparatus, products and methods of the present invention are capable of being incorporated in the form of a variety of embodiments, only a few of which have been illustrated and described above. The invention may be embodied in other forms without departing from its spirit or essential characteristics. The described embodiments are to be considered in all respects only as illustrative and not restrictive, and the scope of the invention is, therefore, indicated by the appended claims rather than by the foregoing description. All changes that come within the meaning and range of equivalency of the claims are to be embraced within their scope.

1. A jacketed hard candy product comprising:
a) a core made of a boiled hard candy containing one or more flavoring and cooling agents; and
b) an outer layer also made of a boiled hard candy and containing one or more flavoring and cooling agents, the outer layer being jacketed onto the core so as to cover at least a majority of the core, and the level of cooling agents in the outer layer being greater than the level of any cooling agents in the core.

2. The product of claim 1 wherein the ratio of the weight of the core to the weight of the outer layer is between about 95:5 and about 70:30.

3. The product of claim 1 wherein the ratio of the weight of the core to the weight of the outer layer is between about 80:20 and about 90:10.

4. The product of claim 1 wherein the composition of the core and the composition of the outer layer are the same except for the level of the one or more flavoring and cooling agents.

5. The product of claim 1 wherein the jacket comprises about 0.01% to about 2% menthol.

6. The product of claim 1 wherein the product comprises between about 0.01% and about 2% flavoring agents.

7. The product of claim 1 wherein the product comprises between about 0.001% and about 1% cooling agents.

8. The product of claim 1 wherein the product is sugarless.

9. The product of claim 1 wherein the boiled hard candies of the core and outer layer are both made from the same bulk sweetener selected from the group consisting of sugars, corn syrup, polyols, hydrogenated starch hydrolysate syrup and combinations thereof.

10. The product of claim 1 wherein the boiled hard candies of the core and outer layer are both made from the same bulk sweetener selected from the group consisting of sucrose, dextrose, lactose, corn syrup and combinations thereof.

11. The product of claim 1 wherein the boiled hard candies of the core and outer layer are both made from the same bulk sweetener selected from the group consisting of hydrogenated isomaltulose, xylitol, maltitol, hydrogenated starch hydrolysate and combinations thereof.

12. The product of claim 8 wherein the boiled hard candy of the core comprises hydrogenated isomaltulose.

13. The product of claim 1 wherein the cooling agent in the outer layer is selected from the group consisting of substituted p-menthane carboxamides, acyclic carboxamides, menthone glycerol ketals, menthyl lactate, menthyl succinate, menthyl glutarate, 3-l-menthoxypropane-1,2 diol and mixtures thereof.

14. The product of claim 1 wherein the one or more flavor and cooling agents used in the core and outer layer comprise N, 2,3-trimethyl-2-isopropyl butanamide at a level of between about 0.002% and about 0.015% of the product.

15. The product of claim 1 wherein the one or more flavor and cooling agents used in the core and the outer layer combined comprise 3-l-menthoxypropane-1,2 diol at a level of between about 0.005% and about 0.05% of the product.

16. The product of claim 1 wherein the boiled hard candies of the core and outer layer both comprises a color.

17. The product of claim 15 wherein the color of the core and of the outer layer are the same.

18. The product of claim 15 wherein the color of the core and of the outer layer are different.

19. The product of claim 1 wherein the one or more flavoring and cooling agents in the core and in the outer layer both comprise menthol, and the ratio of the level of menthol in the outer layer to the ratio of the level of menthol in the core is at least 1.5:1.

20. The product of claim 19 wherein the ratio of menthol level in the outer layer to the menthol level in the core is at least 2:1.

21. The product of claim 1 wherein the product is clear, and the product core and outer layers appear to be homogeneous.

22. A method of making jacketed hard candy products comprising the steps of:
a) cooking a composition to form a first sweetened mass;
b) mixing one or more flavoring and cooling agents into the first sweetened mass;
c) providing a second sweetened mass;
d) mixing one or more flavoring and cooling agents into the second sweetened mass such that the level of the cooling agents in second sweetened mass is higher than the level of any cooling agents in the first sweetened mass; and
e) forming jacketed hard candy products wherein the first sweetened mass is used to form a core and the second sweetened mass is used to form an outer layer covering at least a majority of said core.

23. The method of claim 22 wherein the step of providing a second sweetened mass is accomplished by separating part of the composition after it is cooked but before the one or more flavoring and cooling agents are mixed into it.

24. The method of claim 22 wherein the step of providing a second sweetened mass is accomplished by separating part of the first sweetened mass after the one or more flavoring and cooling agents have been mixed into the first sweetened mass.

25. The method of claim 22 wherein the step of forming comprises forming the first sweetened mass into a continuous rope and adding the second sweetened mass to coat the outside of the continuous rope.

26. The method of claim 22 wherein the first mass comprises one or more flavoring agents but no cooling agents.

27. The method of claim 22 wherein cooling agents used in the second sweetened mass are pre-blended with flavoring agents before being mixed into the second sweetened mass.

28. The method of claim 22 wherein the first and second sweetened mass are coextruded with the second sweetened mass covering the first sweetened mass.

29. A method of making jacketed hard candy products having a fast flavor release comprising the steps of:
a) combining isomalt, water and a high-intensity sweetener to form a blend;
b) vacuum cooking the blend to form a boiled hard candy;
c) separating the boiled hard candy into a core portion and a jacket portion;
d) mixing a first set of flavoring and cooling agents into the core portion and a second set of flavoring and cooling agents into the jacket portion, the level of cooling agents in the jacket portion exceeding the level of any cooling agents in the core portion;
e) combining the core portion and the jacket portion so that the jacket portion covers at least a majority of the core portion to form a jacketed rope;
f) reducing the cross-sectional area of the jacketed rope; and
g) forming individual products from the jacketed rope, the individual products having a core formed from material from the core portion and an outer layer formed from material from the jacket portion.

30. The product of claim 1 wherein the outer layer covers about 80% or more of the core.

31. The product of claim 1 wherein the outer layer covers substantially all of the core.

32. The method of claim 29 wherein substantially all of the core portion of the product is covered by the jacket portion.

33. The product of claim 1 wherein the weight of the outer layer comprises about 15% of the total product.

34. The product of claim 1 wherein the product has an elongated shape.

35. The product of claim 1 wherein the product further comprises one or more high-intensity sweeteners selected from the group consisting of acesulfame K, aspartame, alitame, sucralose, glycyrrhizin, saccharin and cyclamates.

36. The product of claim 35 wherein the high-intensity sweetener is included at a level of about 0.001% to about 2% of the product.

37. The method of claim 29 wherein an in-line mixer is used to mix one or more of the flavor and cooling agents into the boiled hard candy.
